(19) United States
(12) Patent Application Publication
(10) Pub. No.: US 2022/0403863 A1
(43) Pub. Date: Dec. 22, 2022

(54) MECHANICAL CONNECTORS WITH V-SHAPED ENDS AND STRUCTURES FORMED FROM SAME

(71) Applicant: William M. STECKER, Hillsborough, NC (US)

(72) Inventor: William M. STECKER, Hillsborough, NC (US)

(21) Appl. No.: 17/841,133

(22) Filed: Jun. 15, 2022

Related U.S. Application Data
(60) Provisional application No. 63/212,451, filed on Jun. 18, 2021.

(51) Int. Cl. F16B 7/00

(52) U.S. Cl. CPC F16B 7/00

(57) ABSTRACT

A connector includes, an elongate web member, a pair of first and second elongate members extending outward from an end of the web member at a first angle relative to each other to form a V-shape, and a pair of third and fourth elongate members extending outward from an opposite end of the web member at a second angle relative to each other to form a V-shape. The first and second elongate members each have a respective longitudinal free end, and the third and fourth elongate members each have a respective longitudinal free end. The first and second elongate members are slidably engaged with respective receiving slots in a first element, and the third and fourth elongate members are slidably engaged with receiving slots in a second element to join the first and second elements together.

### RELATED APPLICATION

This application claims the benefit of and priority to U.S. Provisional Patent Application No. 63/212,451 filed Jun. 18, 2021, the disclosure of which is incorporated herein by reference as if set forth in its entirety.

### FIELD

The present invention relates generally to connectors and, more particularly, to connectors for connecting structural elements together.

### BACKGROUND

Joining material is fundamental to all construction and assembly projects. Conventionally, connecting parallel surfaces has been accomplished with various materials and devices. Edges may be glued to create wider versions of a material such as wood planks or butcher blocks. These glued edges may be reinforced with the use of dowels, splines or “wood biscuits”. This approach creates a rigid assembly and is typically used in furniture, cabinet and millwork construction. Flexible connections are achieved with the use of various connection systems. Tambour (used in roll top desks and cabinets) is an example of a flexible attachment of parallel surfaces. Parallel members are attached in various ways. Holes may be drilled through slats. A wire is used to connect materials. Alternating canvas or other sheet material is adhered to reverse side of planks using contact cement or other adhesives. This creates a flexible assembly which travels in double tracts.

Hinges, continuous (piano hinges) or staggered are used to connect various parallel surfaces. “Slat” structures such as a picket or plank fences utilize horizontal elements to connect vertical elements with mechanical fasteners such as nails, screws or staples. Sliding dove tails is a method of assembly used in drawer construction joins two surfaces with a male/female combination. A female dovetail groove is machined with a router and special shaped router bit. A corresponding male element is machined to create a reciprocal cross section. Other rigid connections may be created with dovetail, box joint or finger joints.

### SUMMARY

According to some embodiments of the present invention, a connector includes, an elongate web member, a pair of first and second elongate members extending outward from an end of the web member at a first angle relative to each other to form a V-shape, and a pair of third and fourth elongate members extending outward from an opposite end of the web member at a second angle relative to each other to form a V-shape. The first and second elongate members each have a respective longitudinal free end, and the third and fourth elongate members each have a respective longitudinal free end.

According to some embodiments of the present invention, a connector includes an elongate hollow member, a first elongate Y-shaped connector extending outwardly from the elongate hollow member along a length thereof, and a second elongate Y-shaped connector extending outwardly from the elongate hollow member along a length thereof in circumferential spaced-apart relationship with the first elongate Y-shaped connector. The first elongate Y-shaped member includes a pair of first and second elongate members oriented at a first angle relative to each other to form a V-shape, and the first and second elongate members each having a respective longitudinal free end. The second elongate Y-shaped member includes a pair of third and fourth elongate members oriented at a second angle relative to each other to form a V-shape, and the third and fourth elongate members each having a respective longitudinal free end.

According to some embodiments of the present invention, a structure includes a first element having a surface with a pair of angled elongate slots, a second element having a surface with a pair of angled elongate slots, and a connector joining the first and second elements. The connector includes an elongate web member, a pair of first and second elongate members extending outward from an end of the web member at a first angle relative to each other to form a V-shape, and a pair of third and fourth elongate members extending outward from an opposite end of the web member at a second angle relative to each other to form a V-shape. The first and second elongate members each have a respective longitudinal free end, and the third and fourth elongate members each have a respective longitudinal free end. The first and second elongate members are inserted into the pair of angled elongate slots of the first element, and the third and fourth elongate members are inserted into the pair of angled elongate slots of the second element.

According to some embodiments of the present invention, a structure includes a first element having a surface with a pair of angled elongate slots, a second element having a surface with a pair of angled elongate slots, and a connector joining the first and second elements. The connector includes an elongate hollow member, a first elongate Y-shaped connector extending outwardly from the elongate hollow member along a length thereof, and a second elongate Y-shaped connector extending outwardly from the elongate hollow member along a length thereof in circumferential spaced-apart relationship with the first elongate Y-shaped connector. The first elongate Y-shaped member includes a pair of first and second elongate members oriented at a first angle relative to each other to form a V-shape, and the first and second elongate members each have a respective longitudinal free end. The first and second elongate members are inserted into the pair of angled elongate slots of the first element. The second elongate Y-shaped member includes a pair of third and fourth elongate members oriented at a second angle relative to each other to form a V-shape, and the third and fourth elongate members each have a respective longitudinal free end. The third and fourth elongate members are inserted into the pair of angled elongate slots of the second element.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1A is a perspective view of a connector according to some embodiments of the present invention.

FIG. 1B is a cross-sectional view of the connector of FIG. 1A.

FIG. 1C illustrates the connector of FIG. 1A joining two elements together to form a structure.

FIG. 2A is a perspective view of a connector according to some embodiments of the present invention.

FIG. 2B is a cross-sectional view of the connector of FIG. 2A.

FIG. 2C illustrates the connector of FIG. 2A joining two elements together to form a structure.

FIG. 3A is a perspective view of a connector according to some embodiments of the present invention.

FIG. 3B is a cross-sectional view of the connector of FIG. 3A.

FIG. 3C illustrates the connector of FIG. 3A joining two elements together to form a structure.

FIG. 4A is a perspective view of a connector according to some embodiments of the present invention.

FIG. 4B is a cross-sectional view of the connector of FIG. 4A.

FIG. 4C illustrates the connector of FIG. 4A joining two elements together to form a structure.

FIG. 4D is a side view of the structure of FIG. 4C with a threaded rod inserted through the tube of the connector and that is used to anchor the structure to a foundation.

FIG. 5A is a perspective view of a connector according to some embodiments of the present invention.

FIG. 5B is a cross-sectional view of the connector of FIG. 5A.

FIG. 5C illustrates the connector of FIG. 5A joining three elements together to form a structure.

FIG. 6A is a perspective view of a connector according to some embodiments of the present invention.

FIG. 6B is a cross-sectional view of the connector of FIG. 6A.

FIG. 6C illustrates the connector of FIG. 6A joining four elements together to form a structure.

FIG. 7A is a perspective view of a connector apparatus according to some embodiments of the present invention.

FIG. 7B is a cross-sectional view of the connector apparatus of FIG. 7A.

FIG. 7C illustrates the connector apparatus of FIG. 7A joining four elements together to form a structure.

FIG. 8A is a perspective view of a connector according to some embodiments of the present invention.

FIG. 8B is a cross-sectional view of the connector of FIG. 8A.

FIG. 8C illustrates the connector of FIG. 8A joining eight elements together to form a structure.

FIG. 9A is a perspective view of a connector according to some embodiments of the present invention.

FIG. 9B is a cross-sectional view of the connector of FIG. 9A.

FIG. 9C is a side view of a panel secured between two of the connectors of FIG. 9A.

FIG. 9D is a top view of the panel and connectors illustrated in FIG. 9C.

FIG. 10A is a perspective view of multiple elements joined together via connectors to form a double wall structure according to some embodiments of the present invention,

FIG. 10B is a top view of the double wall structure of FIG. 10A with a material such as concrete or insulation between the two walls.

FIG. 10C is a side view of the double wall structure of FIG. 10B.

FIGS. 11A-11B illustrate an example structure that can be used as a concrete form, according to some embodiments of the present invention.

FIGS. 12A-12C illustrate an example structure that can be used as a liquid containment structure, according to some embodiments of the present invention.

FIG. 13 illustrates a connector that can be used to secure slats to a joist, according to some embodiments of the present invention.

FIGS. 14A-14B illustrate a round wooden building with functional double helix staircases both inside and outside the building fabricated using connectors of the present invention.

FIG. 14C is a cross section view of the outer wall of the building of 14A-14B at location of a connector with an elongate tube and threaded rod therein.

FIGS. 15A-15G illustrate a staircase structure that can be created utilizing connectors of the present invention.

FIG. 16A are perspective views of two connectors for use in creating a hinge, according to some embodiments of the present invention.

FIGS. 16B-16C illustrate a hinge structure that can be created utilizing the connectors of 16A.

FIGS. 17A-17B illustrate a curved structure that can be created utilizing connectors of the present invention.

### DETAILED DESCRIPTION

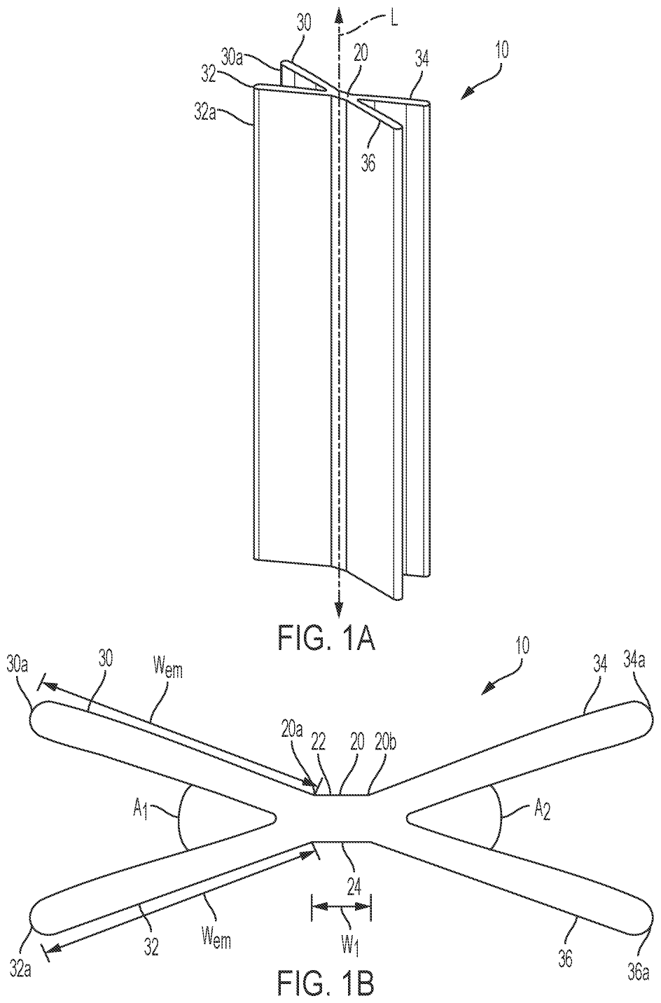

Embodiments of the present invention provide methods of attachment having many advantages, practical and aesthetic, over traditional attachment methods. An advantage of the present invention for attaching parallel materials results from the elegant and unique cross-sectional geometries of its numerous embodiments. Referring to FIGS. 1A-1C, a connector 10 includes an elongate web member 20 having opposite first and second faces 22, 24. A pair of first and second elongate members 30, 32 extend outward from one end 20a of the web member 20 at a first angle A₁ relative to each other. The first and second elongate members 30, 32 form a “V” shape when the connector 10 is viewed in cross-section (FIG. 1B), and each of the first and second elongate members 30, 32 has a respective longitudinal free end 30a, 32a. A pair of third and fourth elongate members 34, 36 extend outward from an opposite end 20b of the web member at a second angle A₂ relative to each other. The third and fourth elongate members 34, 36 form a “V” shape when the connector 10 is viewed in cross-section (FIG. 1B), and each of the third and fourth elongate members 34, 36 has a respective longitudinal free end 34a, 36a.

Each of the first and second angles A₁ and A₂ may be between about ten degrees and about seventy degrees (10° -)70°, although embodiments of the present invention are not limited to any particular angle for the first angle A₁ and the second angle A₂. In some embodiments, the first and second angles A₁, A₂ are the same. In other embodiments, the first and second angles A₁, A₂ are different.

In the illustrated embodiment, the first and second elongate members 30, 32 have a width Wₑₘ from the web member end 20a to the respective free ends 30a, 32a that is the same. Similarly, the third and fourth elongate members 34, 36 have a width Wₑₘ from the web member end 20b to the respective free ends 34a, 36a that is the same. Moreover, in the illustrated embodiment, the first, second, third, and fourth elongate members all have a width Wₑₘ that is the same. However, a connector 10 according to some embodiments of the present invention may have first and second elongate members 30, 32 with different respective widths Wₑₘ and/or different respective widths Wₑₘ from the third and fourth elongate members 34, 36. Moreover, the first and second elongate members 30, 32 can have different widths Wₑₘ from each other. Similarly, the third and fourth elongate members 34, 36 can have different widths Wₑₘ from each other.

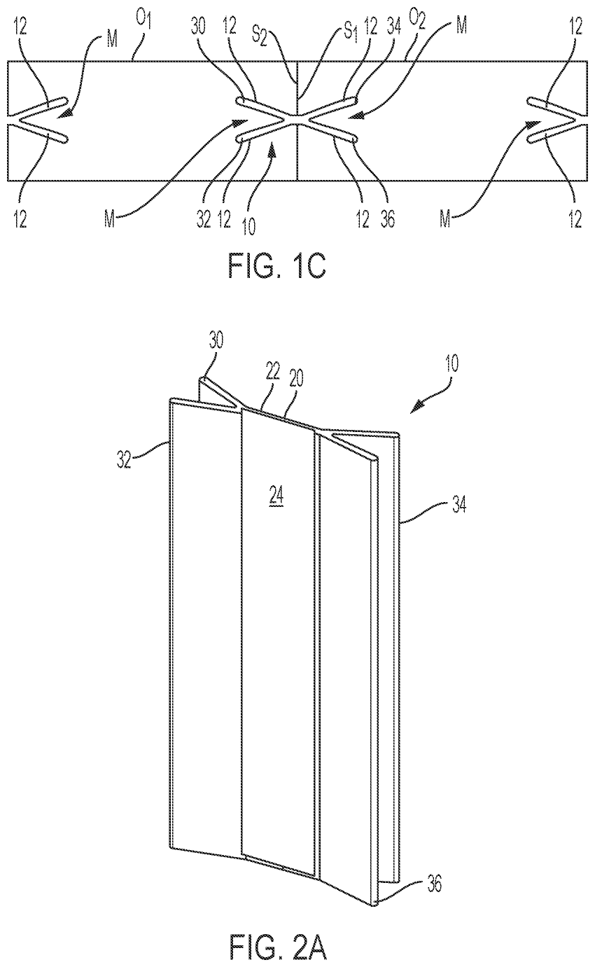

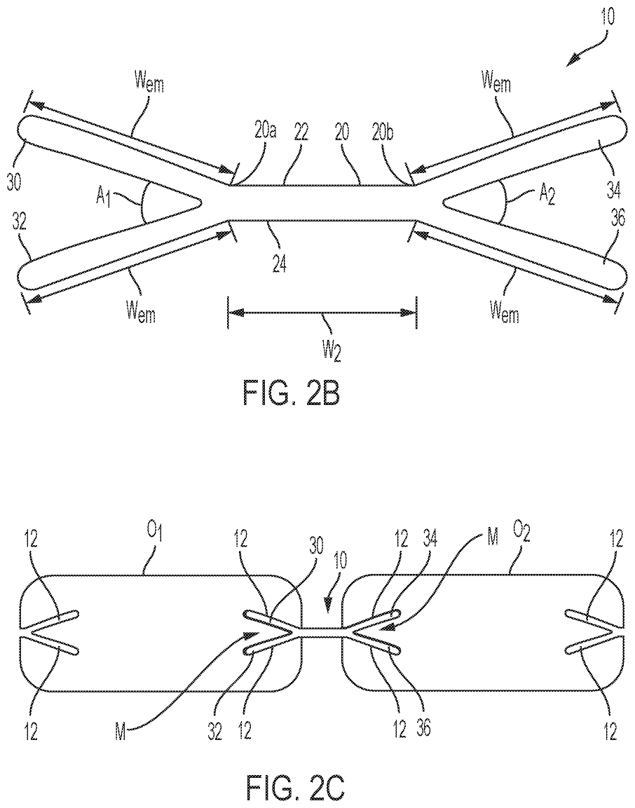

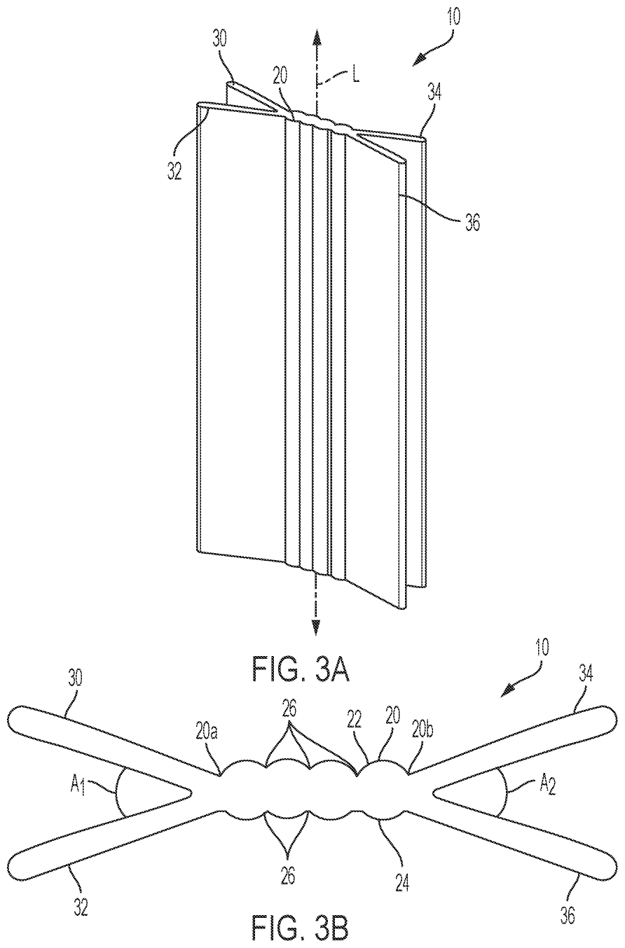

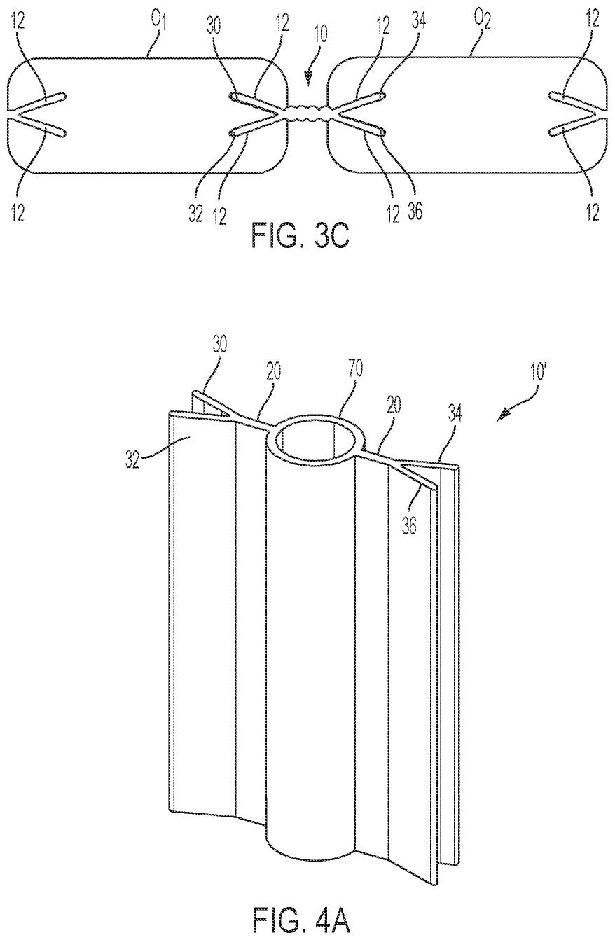

The web member 20 can have various widths W₁ based on the intended function of the connector 10. For example, the web member 20 of the connector 10 in FIGS. 1A-1C has a width W₁ that is less that a width W₂ of the web member 20 of the connector 10 in FIGS. 2A-2C. Moreover, the web member 20 can have various shapes and configurations. In some embodiments, the web member 20 is bendable about a longitudinal axis L thereof. For example, as illustrated in FIGS. 3A-3C, the first and second faces 22, 24 may have a “fluted” configuration with a plurality of elongate, parallel grooves 26 that facilitate bending of the web member 20 about the longitudinal axis L thereof.

The connectors 10 illustrated in FIGS. 1A-1C, 2A-2C, 3A-3C may be fabricated (e.g., extruded) from various materials, including aluminum and polymeric materials. In some embodiments, a connector 10 may be extruded from aluminum and an outer surface of the connector 10 includes an anodized coating.

The connector 10 illustrated in FIGS. 1A and 1B is used to connect two objects O₁, O₂ and draw the respective surfaces S₁, S₂ of objects O₁, O₂ into intimate contact, as illustrated in FIG. 1C. The objects O₁, O₂ may include anything that is typically joined together to create a structure, such as panels, planks, etc. The degree of contact may be adjusted by the relationship between the V-shaped ends of the connector 10 and the in/out positioning of the receiving slots 12 in each object O₁, O₂. Each receiving slot 12 can be created with standard circular saw blades tilted to the required angle. To connect the two objects O₁, O₂ together, the elongate members 30, 32 and 34, 36 slidably engage the respective receiving slots 12 in the first and second objects O₁, O₂.

Typically, the angle of each receiving slot 12 is about twenty degrees (20°), creating an included angle between the receiving slots of about forty degrees (40°). Accordingly, the elongate members 30, 32 and 34, 36 have corresponding angles A₁, A₂ of forty degrees (40°). While a wide range of angles would potentially work, for example ten degrees (10°) to about seventy degrees (70°), Applicant has discovered that forty degrees (40°) provides sufficient resistance to pull apart forces.

The V-shaped configuration of the receiving slots 12 removes less material from an object than a conventional sliding dovetail. The V-shaped slots also can be machined at high speed with circular saw blades while a conventional dovetail must be cut with low speed router bits. A significant advantage of the V-shaped receiving slot design of the present invention is the retention of the wedge-shaped material M (FIG. 1C) between the receiving slots 12. The V-shaped slots 12 involve less disruption of the structural integrity of the object in which they are formed. When tensile forces are applied to joints created with embodiments of the present invention, the V-shaped elongate members 30, 32 and 34, 36 of the connector 10 are forced to clamp on the remaining wedge shape structure in the objects O₁, O₂. A traditional dovetail, on the other hand, acts like a splitting wedge which is much less resistant to pull apart tensile forces. The V-shaped configuration of the elongate members 30, 32 and 34, 36 of the connector 10 is very important in applications where a structure created by the connector 10 is subject to forces such as wind, water, or soil backfill.

In most cases the first angle A₁ and second angle A₂ of the elongate members 30, 32 and 34, 36 are the same as the angles of the receiving slots 12 in the first and second objects Oi, 02. However, in some embodiments, tight joinery may be achieved by altering the angle of the receiving slots 12 in each object O₁, O₂. For example, the receiving slots 12 may have an angle that is greater than the first and second angles A₁, A₂ of the elongate members 30, 32 and 34, 36. When the connector 10 is inserted (forced) simultaneously into the opposing receiving slots 12, the elongate members 30, 32 and 34, 36 are forced to splay to accommodate the greater angle of the respective receiving slots 12. A connector 10 formed from aluminum, flexible plastic, or other flexible material will allow the elongate members 30, 32 and 34, 36 to splay. This results in creating a tension on the web member 20 of the connector 10, pulling the joint between two objects together.

In some embodiments, adhesive may be applied to the receiving slots 12 prior to insertion of the respective elongate members 30, 32 and 34, 36. The addition of adhesive may enable the creation of a joint with greater strength than possible with either glue or fasteners alone.

Joints created with the connector 10 are elegant, strong and, when desired, aesthetically pleasing. Various embodiments of the connector 10 with web member 20 and the “V-shaped” prong ends are possible as illustrated in FIGS. 1A-1C, FIGS. 2A-2C, FIGS. 3A-3C, FIGS. 4A-4C, FIGS. 5A-5C, FIGS. 6A-6C, FIGS. 7A-7C, FIGS. 8A-8C, and FIGS. 9A-9D. Depending on the material used to form the connector 10, joints created between objects may be flexible (polymer connector) or semi-flexible (aluminum connector), for example. Joints created with connectors of the present invention may behave like traditional tambour, and may also behave with hinge-like functionality. For example, a semi-rigid connector 10 allows for serpentine, round, or other curved surfaces to be configured by bending of the web member 20 of a connector. This functionality enables the creation of complex structures large and small.

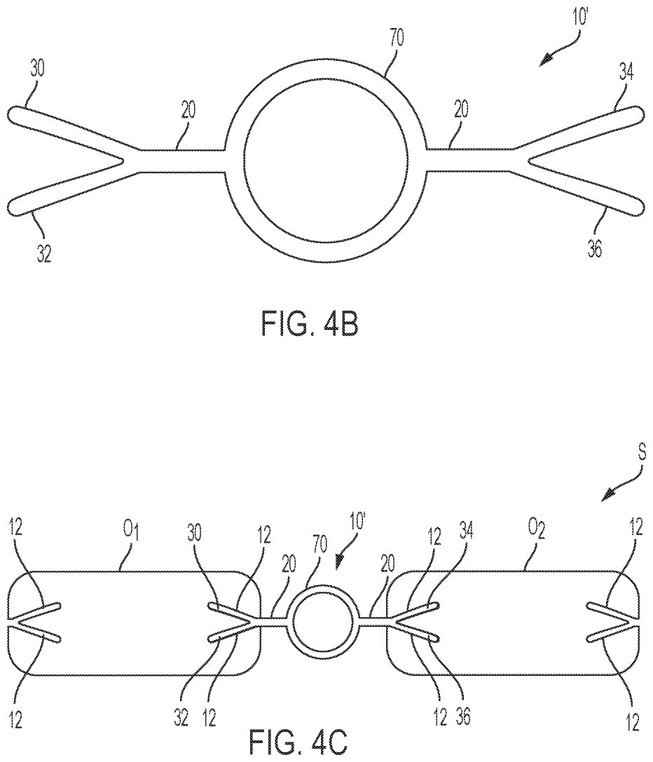

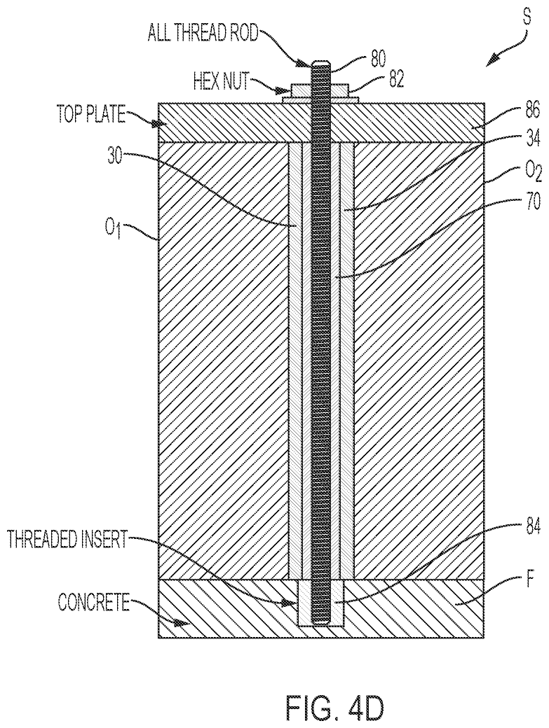

In some embodiments of the present invention, a connector 10′ may include an elongate tube 70 and multiple web members 20 connected to the tube 70, each with a V-shaped end, as illustrated in FIGS. 4A-4C, FIGS. 5A-5C, FIGS. 6A-6C, and FIGS. 8A-8C. The tube 70 provides additional functionality by enabling structures to be aligned with and/or connected to concrete, wood, or other foundations. This may be achieved with, for example, rebar or threaded rod that is inserted through the tube 70.

The connectors 10′ illustrated in FIGS. 4A-4C, FIGS. 5A-5C, FIGS. 6A-6C, and FIGS. 8A-8C may be fabricated (e.g., extruded) from various materials, including aluminum and polymeric materials. In some embodiments, a connector 10′ may be extruded from aluminum and an outer surface of the connector 10′ includes an anodized coating.

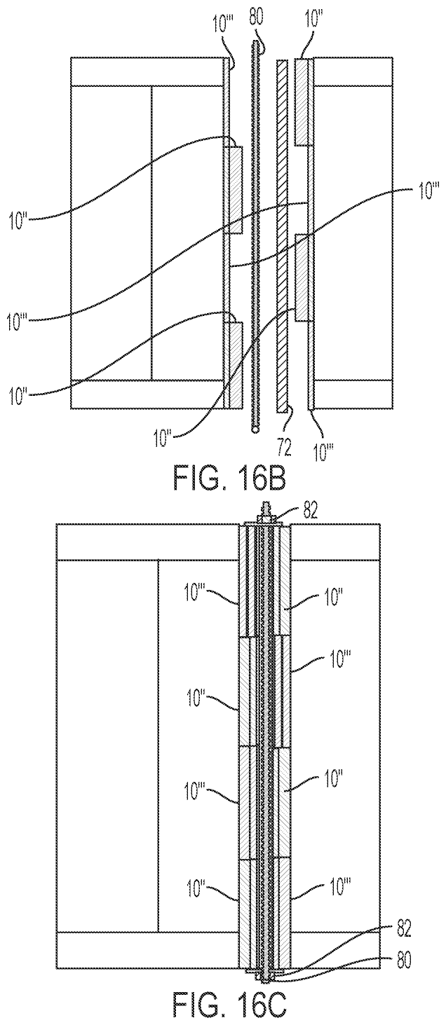

FIGS. 4A-4B illustrate a connector 10′ that includes an elongate tube 70 with two elongate web members 20 extending outwardly in opposing directions for connecting two objects O₁, O₂ together to form a structure S (FIG. 4C). One web member 20 includes V-shaped elongate members 30, 32, and the other web member 20 includes V-shaped elongate members 34, 36. Each web member 20 and respective elongate members connected thereto can be referred to as an elongate “Y-shaped” connector. Thus, the connector embodiment of FIGS. 4A-4C has two Y-shaped connectors. However, embodiments of connector 10′ can have various numbers of Y-shaped connectors, including a single Y-shaped connector (FIG. 16A, for example).

The tube 70 is configured to receive a threaded rod, rebar, or other elongate member therethrough for anchoring a structure S to a foundation. FIG. 4L) is a side sectional view of the structure of FIG. 4C with a threaded rod 80 inserted through the tube 70 of the connector 10′ and that is used to anchor the structure S to a foundation F. In the illustrated embodiment, a threaded insert 84 is embedded in the foundation F (e.g., concrete, etc.) and the threaded rod 80 is threadingly secured to the threaded insert 84. A top plate 86 is placed over the structure S and a nut 82 is threaded onto the threaded rod 80 to secure the structure S to the foundation F, as would be understood by one skilled in the art.

The tube 70 can have various cross-sectional configurations. For example, the tube 70 can have a substantially circular or oval cross-sectional configuration, or a substantially polygonal cross-sectional configuration, i.e., square, rectangular, triangular, hexagonal, etc.

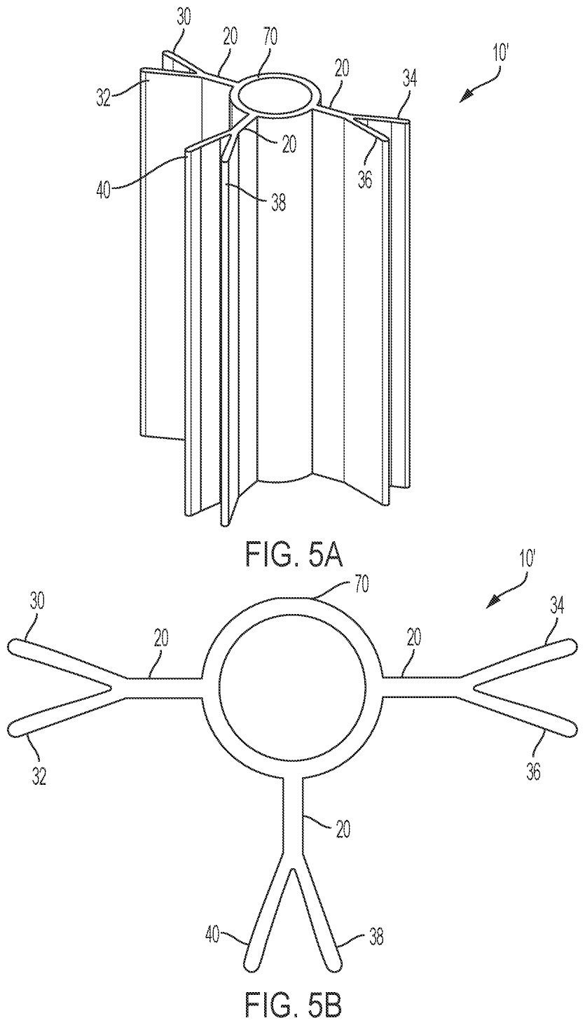

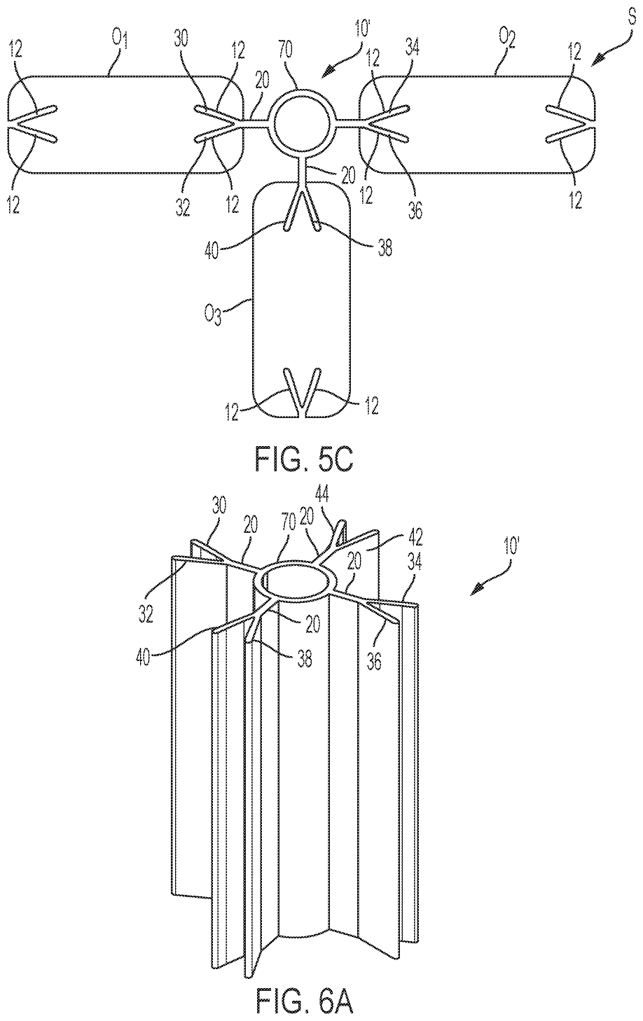

FIGS. 5A-5B illustrate a connector 10′ that includes a tube 70 with three Y-shaped connectors extending outwardly as illustrated for connecting three objects O₁, O₂, 03 together to form a structure S (FIG. 5C). A first web member 20 includes V-shaped elongate members 30, 32, a second web member 20 includes V-shaped elongate members 34, 36, and a third web member 20 includes V-shaped elongate members 38, 40.

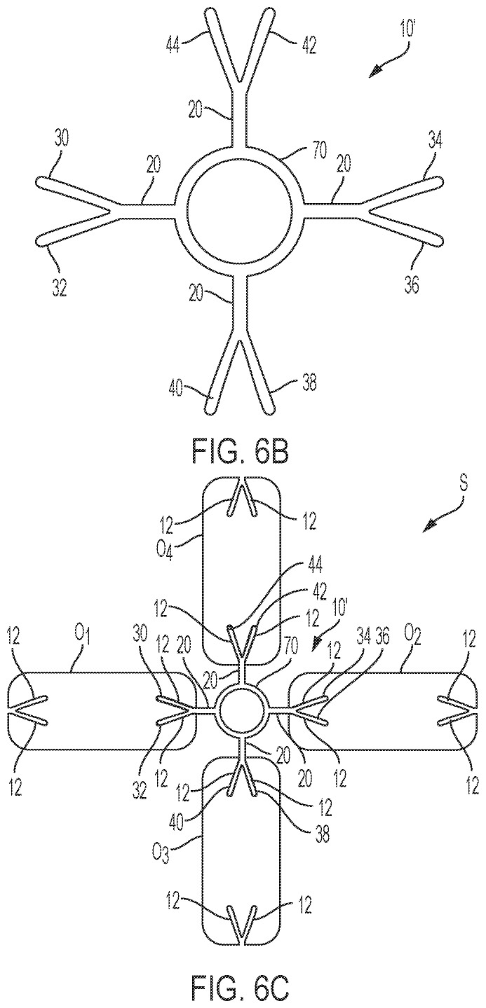

FIGS. 6A-6B illustrate a connector 10′ that includes a tube 70 with four Y-shaped connectors extending outwardly as illustrated for connecting four objects O₁, O₂, O₃, O₄ together to form a structure S (FIG. 6C). A first web member 20 includes V-shaped elongate members 30, 32, a second web member 20 includes V-shaped elongate members 34, 36, a third web member 20 includes V-shaped elongate members 38, 40, and a fourth web member 20 includes V-shaped elongate members 42, 44.

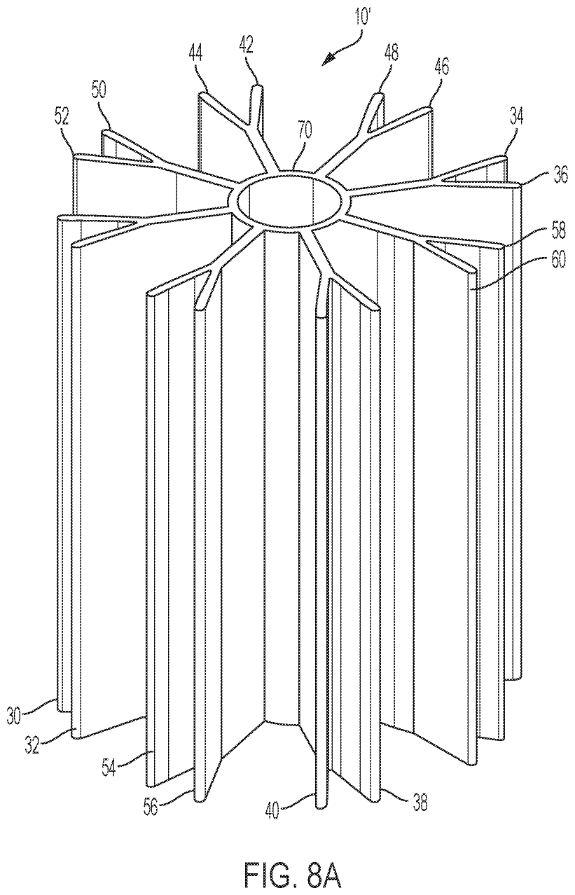

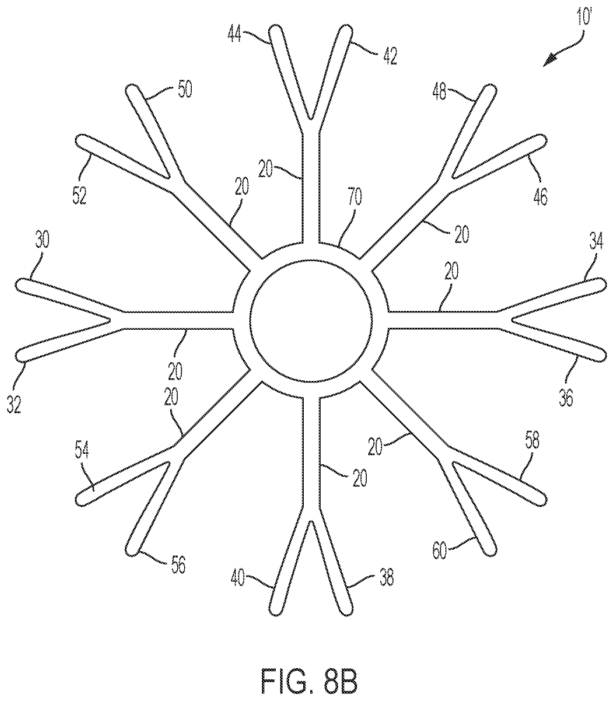

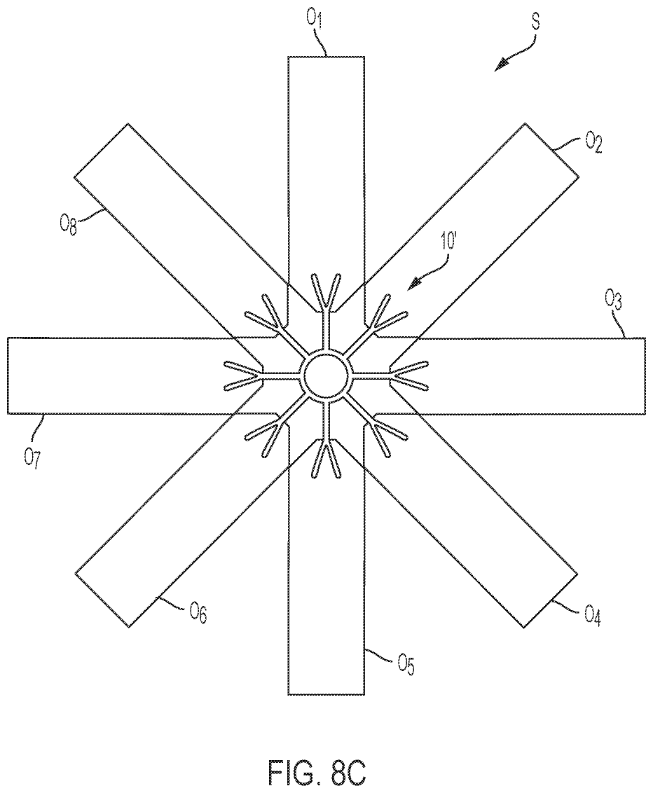

FIGS. 8A-8B illustrate a connector 10′ that includes a tube 70 with eight Y-shaped connectors extending outwardly as illustrated for connecting eight objects O₁, O₂, O₃, O₄, O₅, O₆, O₇, O₈ together to form a structure S (FIG. 8C). A first web member 20 includes V-shaped elongate members 30, 32, a second web member 20 includes V-shaped elongate members 34, 36, a third web member 20 includes V-shaped elongate members 38, 40, a fourth web member 20 includes V-shaped elongate members 42, 44, a fifth web member 20 includes V-shaped elongate members 46, 48, a sixth web member 20 includes V-shaped elongate members 50, 52, a seventh web member 20 includes V-shaped elongate members 54, 56, and an eighth web member 20 includes V-shaped elongate members 58, 60.

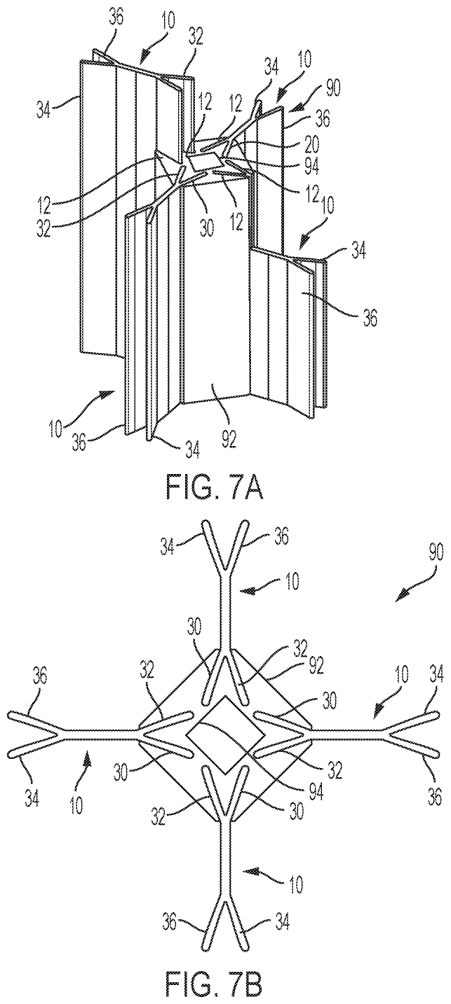

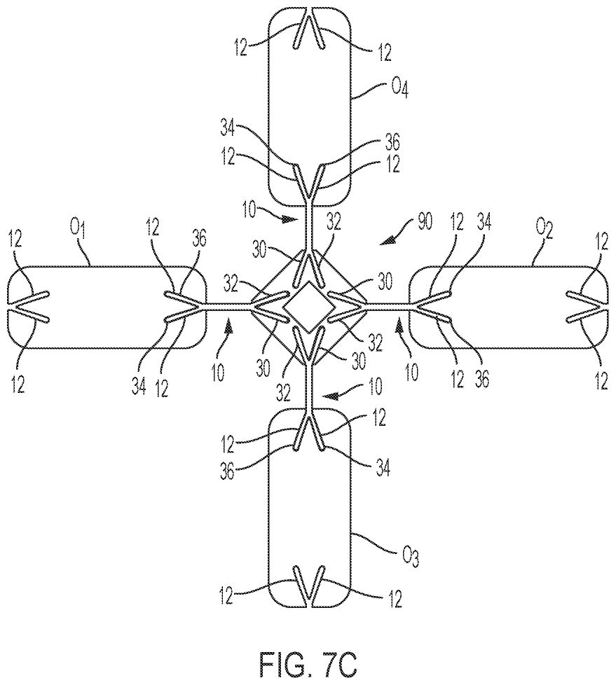

FIGS. 7A-7B illustrate a connector apparatus 90 according to another embodiment of the present invention. The connector apparatus 90 includes an elongate base 92 with a channel 94 formed therethrough along a longitudinal axis thereof. The channel 94 is configured to receive rebar, a threaded rod, or other elongate member therethrough similar to the tube 70 described above. The illustrated base 92 has a rectangular cross-sectional shape with V-shaped slots 12 formed therein at the corners of the base 92. However, embodiments of the present invention are not limited to the base having a rectangular cross-sectional shape. The base may have any cross-sectional shape, without limitation. Moreover, the receiving slots 12 can be formed in other portions of the base 92 and are not required to be located at the corners of the base 92.

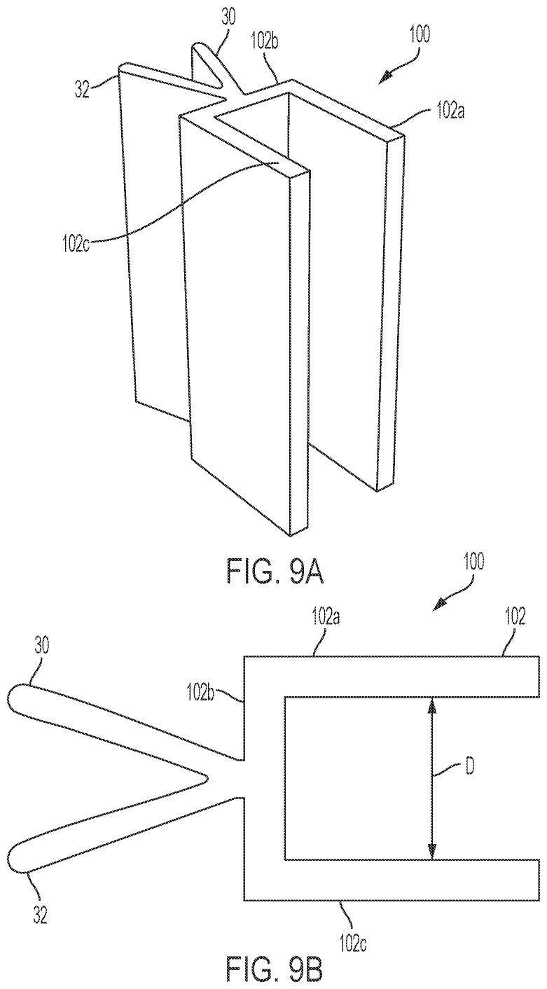

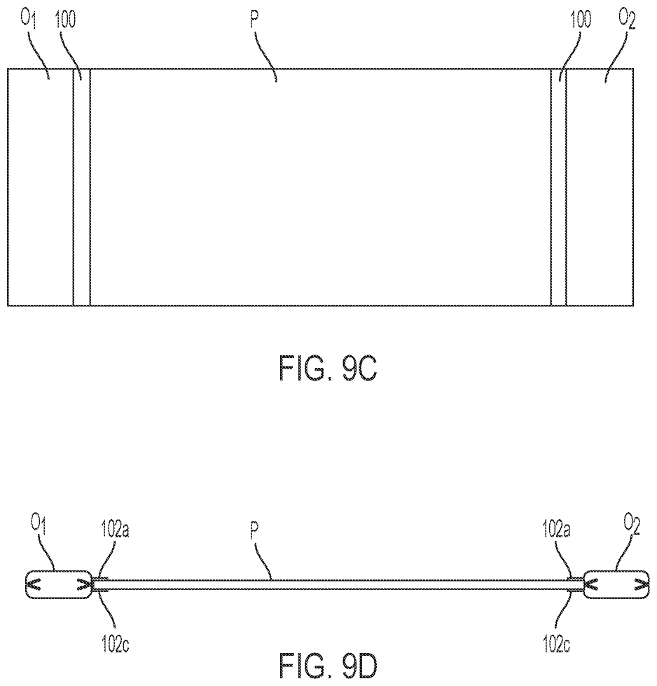

A connector 10, as described with respect to FIGS. 2A-2B, is attached to the base 92 at each corner, as illustrated. The respective V-shaped elongate members 30, 32 of each connector 10 are slidably received in the respective V-shaped receiving slots 12. As illustrated in FIG. 7C, the V-shaped elongate members 34, 36 of each connector 10 are slidably engaged with respective receiving slots 12 in objects O₁, O₂, O₃, O₄ to create a structure S. As with the embodiments described with respect to FIGS. 4A-4C, FIGS. 5A-5C, FIGS. 6A-6C, and FIGS. 8A-8C, rebar, a threaded rod, or other elongate member can be inserted through the channel 94 to secure the structure S to a foundation. FIGS. 9A-9B illustrate a connector 100 configured to support a panel, according to some embodiments of the present invention. The connector 100 includes a bracket 102 and V-shaped elongate members 30, 32 extending from a rear wall 102b of the bracket 102. The V-shaped elongate members 30, 32 are configured to slidably engage with respective receiving slots 12 in an object, as described above. The bracket includes spaced apart side walls 102a, 102c extending from the rear wall 102b, that are configured to receive a portion of a panel therebetween. FIGS. 9C-9D illustrate two connectors 100 secured to respective objects O₁, O₂, and a panel supported therebetween. Any type of panel can be supported by the connectors 100 without limitation. Example panels include metal panels, wood panels, and glass panels. The distance D between the walls 102a, 102c can vary depending upon the thickness of the panel to be supported.

Embodiments of the present invention provide methods of attachment which have many advantages, practical and aesthetic, over traditional methods. Joints created with the connectors of the present invention are simple to create, strong and, when desired, aesthetically attractive. Examples of field of use for the connectors of the present invention include, but are not limited to, concrete forms, flood and erosion control, landscaping and terracing, building construction, furniture and cabinet assembly, decorative walls, etc.

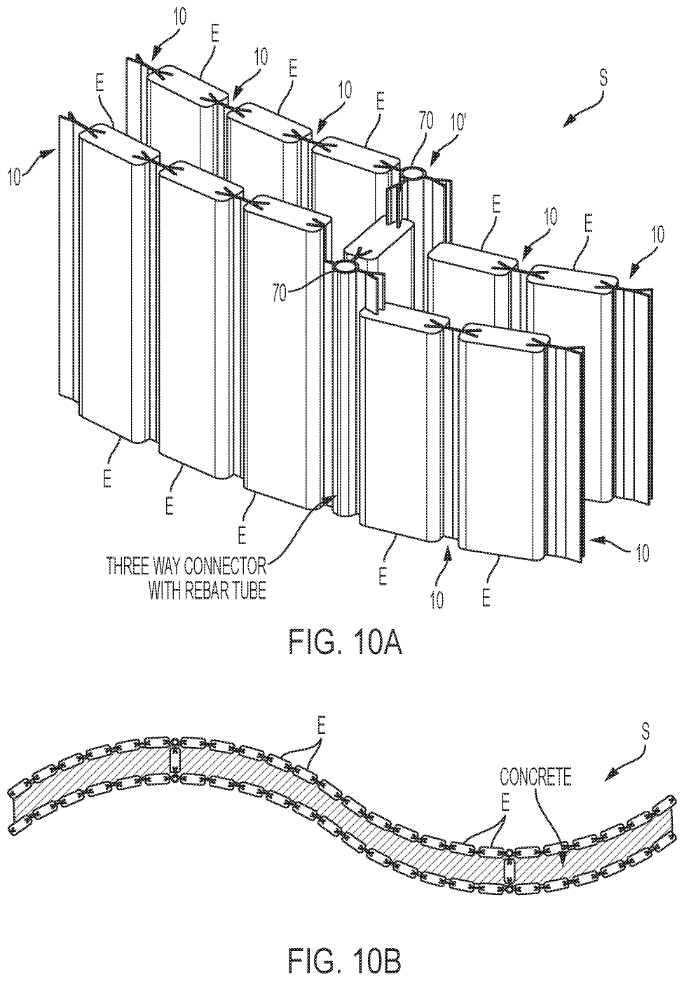

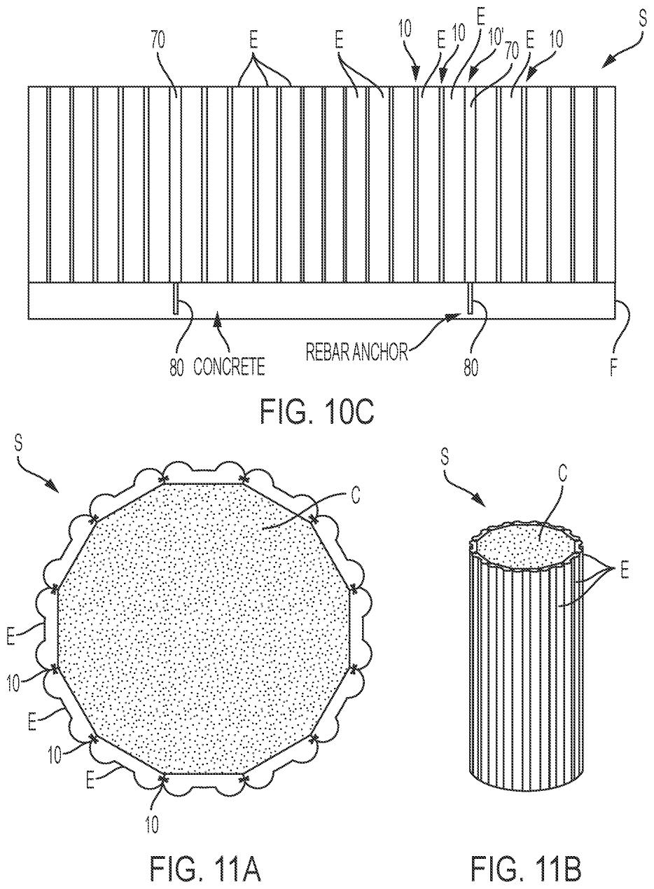

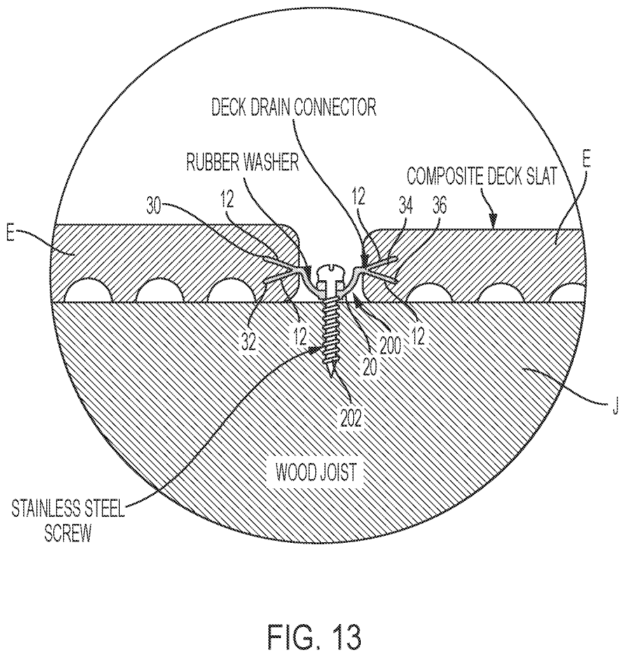

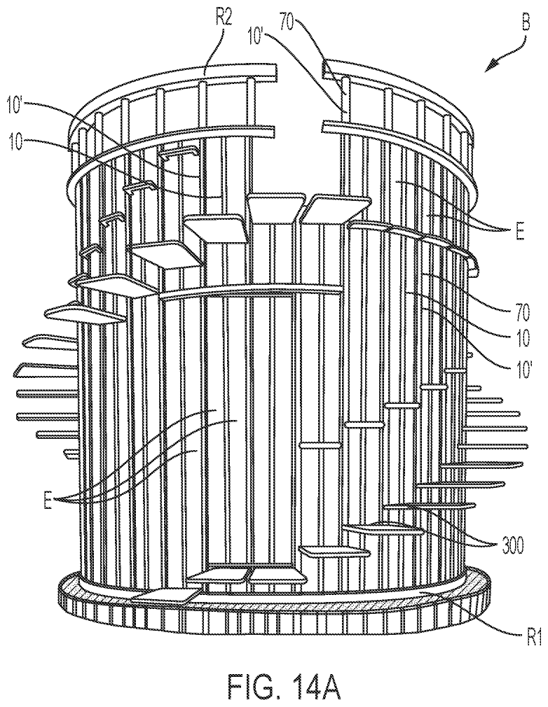

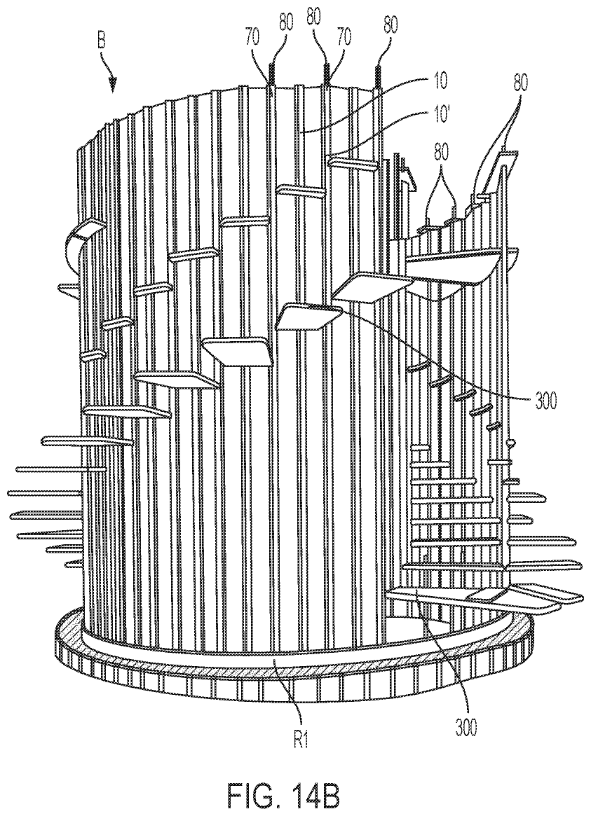

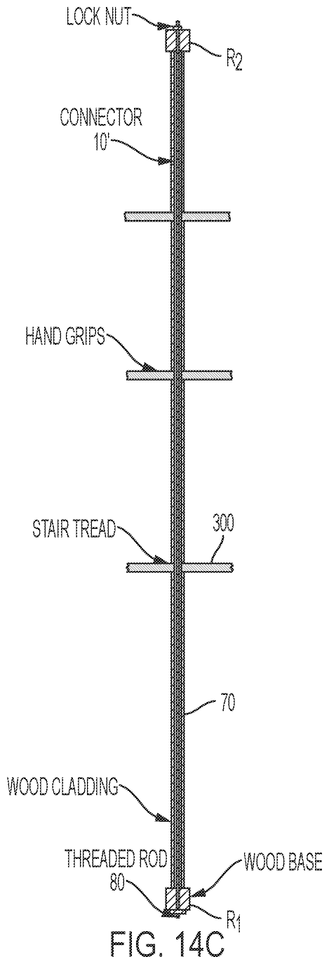

Example structures that can be constructed using connectors according to embodiments of the present invention are illustrated in FIGS. 10A-10C, FIGS. 11A-11B, FIGS. 12A-12C FIG. 13, FIGS. 14A-14C, FIG. 15A, FIGS. 16A-16C, and FIGS. 17A-17B.

FIGS. 10A-10C illustrate multiple elongate members E, such as wood or composite material boards, joined together via connectors 10, 10′ to form a double wall structure S. Concrete insulation, or other material can be placed within the double wall structure (FIG. 10B) and the entire structure S can be secured to a foundation F via rebar, threaded rods, or other elongate members 80 extending through the tubes 70 of the various connectors 10′ (FIG. 10C).

FIGS. 11A-11B illustrate an example structure S that can be used as a concrete form, according to some embodiments of the present invention. Elongate members E, such as wood or composite material boards, are joined together using the connector 10 illustrated in FIGS. 1A-1C to create the form. As described with respect to FIGS. 1A-1C, the V-shaped elongate members of each connector 10 are inserted within respective receiving slots formed within the members E. The form may be permanent or temporary. In some embodiments, the members E may be left in place for aesthetic or practical reasons after the concrete C is poured within the form and cured. In other embodiments, the members E are removable and may have a decorative machined surface that is used to impart patterns the surface of the concrete C.

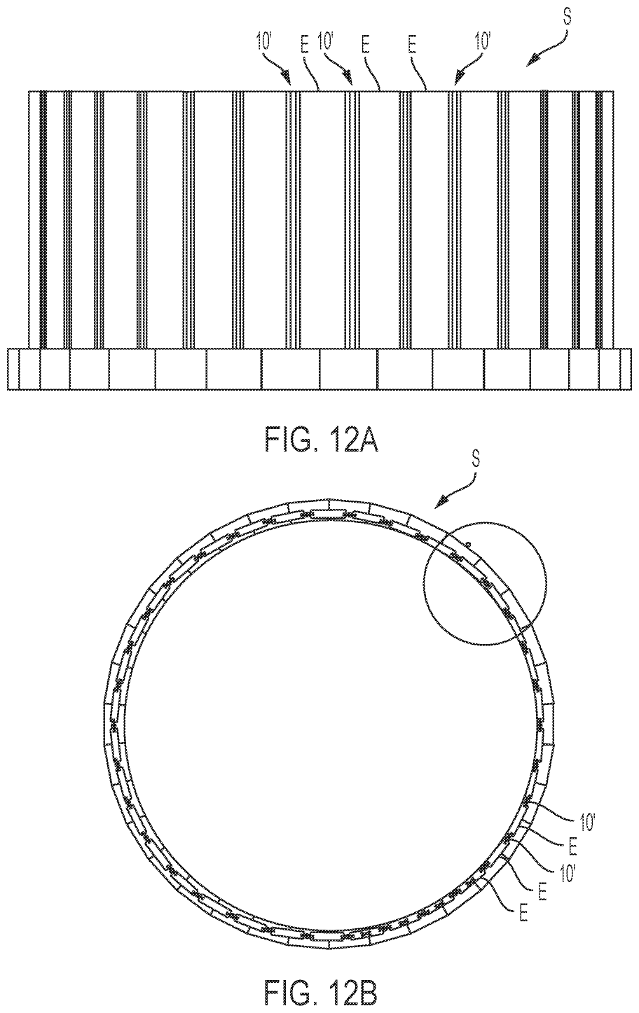

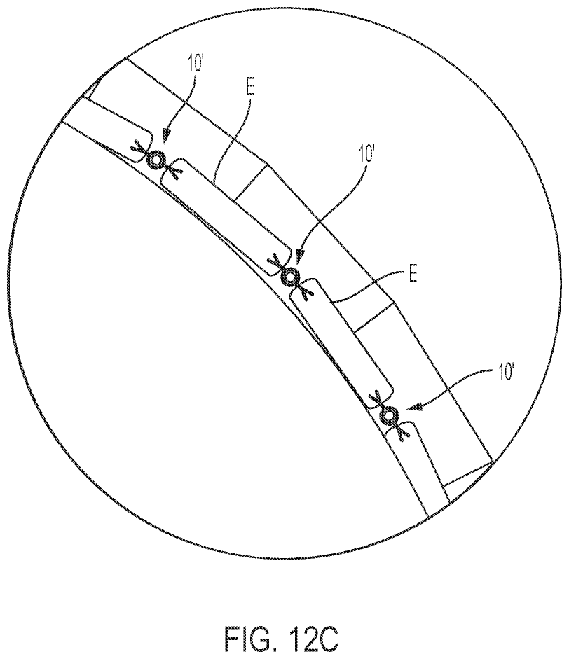

FIGS. 12A-12C illustrate an example structure S (e.g., a pool or tub) that can be used for containing liquid, such as water, according to some embodiments of the present invention. Connectors 10′, as illustrated in FIGS. 4A-4B are utilized to secure planks E together, as described above. The V-shaped elongate members of each connector 10′ are glued in place to help provide a watertight seal.

FIG. 13 illustrates a connector 200 that can be used to secure members E, such as deck slats, etc., to a joist J, according to some embodiments of the present invention. The connector 200 is similar to the connector 10 illustrated in FIGS. 2A-2B; however, the web member 20 between the V-shaped elongate members 30, 32 and 34, 36 is curved and configured to receive a fastener 202, such as a nail or screw, therethrough. Similar to the connector 10 illustrated in FIGS. 2A-2B, the V-shaped elongate members 30, 32 and 34, 36 are inserted within respective receiving slots 12 formed within the members E. Rather than shooting screws through the face of the deck slats, this method attaches the slats to the joists effectively and attractively.

FIGS. 14A-14B illustrate a round wooden building B with functional double helix staircases 300 both inside and outside the building B. The building B is entirely constructed using boards E connected together via the connectors 10, 10′ of the present invention. No nails or screws are required, as in typical wood structures. Threaded rods 80 extend through tubes 70 in respective connectors 10′ as described above and tie all the parts together in tension from the base ring R1 to the rail ring R2 at the top of the building B, as shown in FIG. 14C. The resulting structure is extremely rigid.

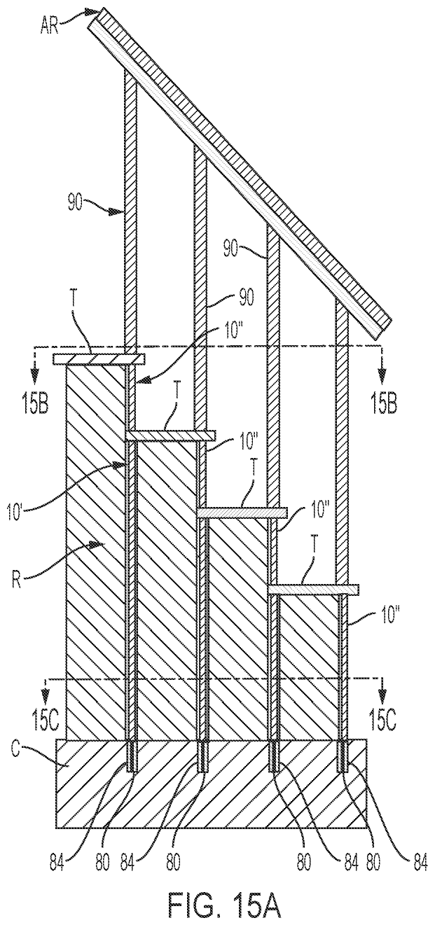

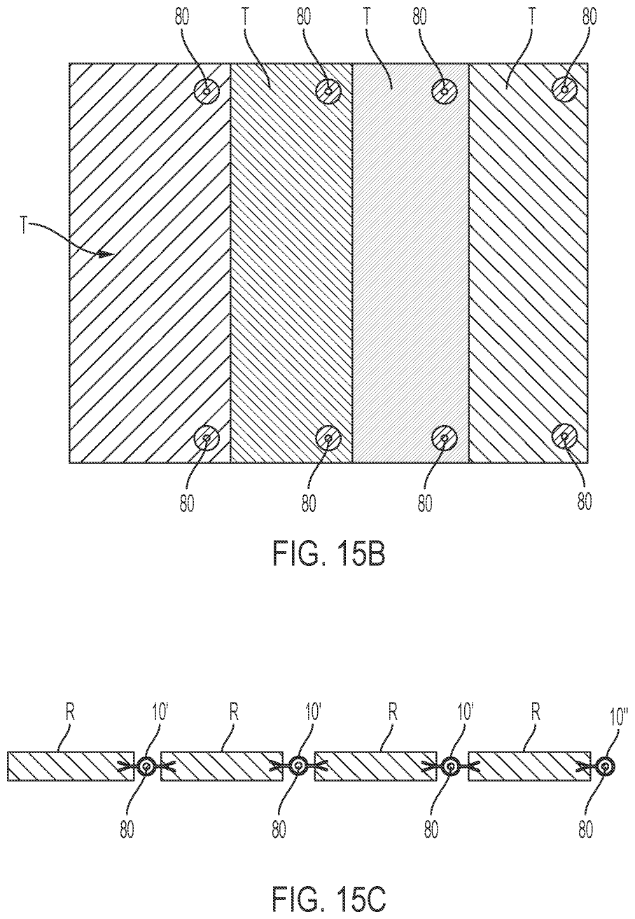

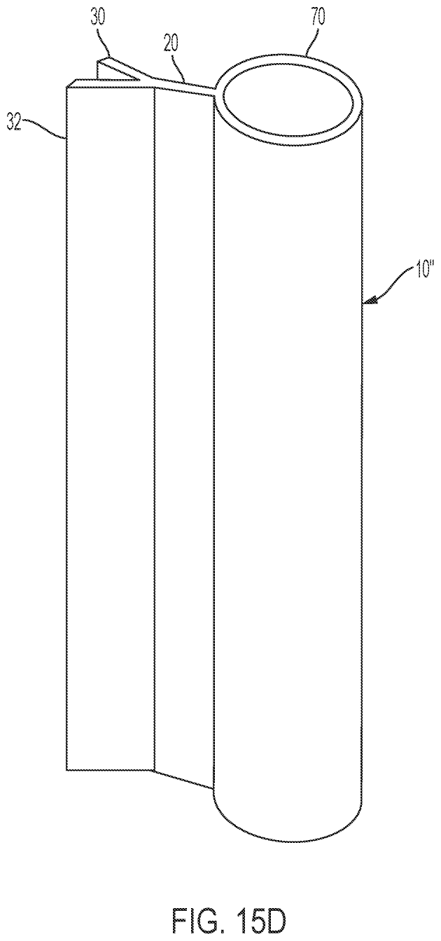

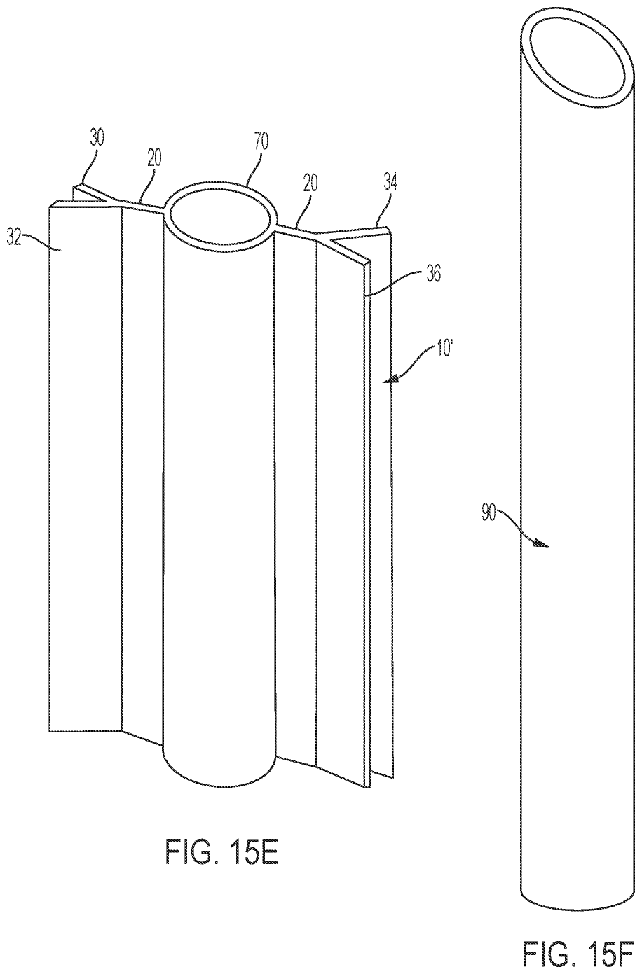

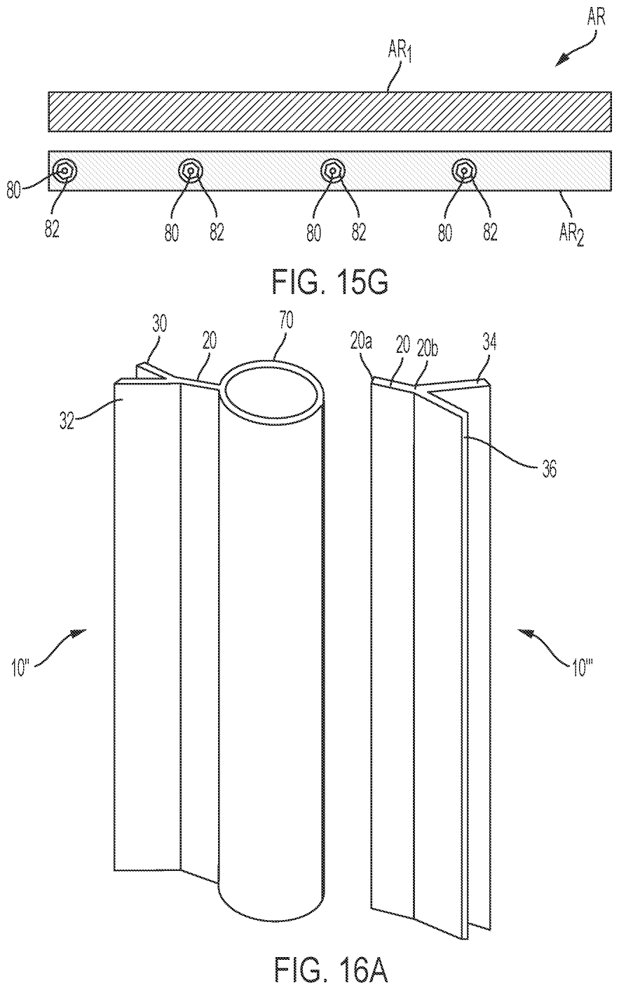

FIGS. 15A-15G illustrate a staircase structure S that can be created utilizing connectors 10′ and 10″ and threaded rods 80. The staircase includes stair treads T supported by risers R on opposite ends of the treads T, as illustrated. The risers R are joined together by connectors 10′ (FIG. 15E), as illustrated in FIG. 15C. A tread T is then placed on the supporting edges of a respective pair of risers R, and then connector 10″ (FIG. 15D) extends above each tread T to the next higher tread T, as illustrated in FIG. 15A. Hollow tubes 90 (FIG. 15F) extend above each tread T and an arm rail assembly AR is placed on top of the hollow tubes 90. Threaded rods 80 are then extended through the assembled structure from the arm rail assembly AR to anchors 84 embedded in a foundation, such as concrete C. Each threaded rod 80 extends through an. aperture in arm rail member AR₂ (FIG. 15G), through the hollow tube 90, through an aperture in a tread T (FIG. 15B), through the tubes 70 of each connector 10′, 10″ and threadingly engages a respective anchor 84. A nut 82 (FIG. 15G) then is threaded onto each threaded rod 80 and tightened to place the structure in tension. Arm rail member AR₁ may then be attached to arm rail member AR₂ for decorative purposes.

FIG. 16A illustrates two connectors 10″, 10′″ that can be utilized to create a hinge structure, according to some embodiments of the present invention. Connector 10″ includes an elongate tube 70 with a Y-shaped connector extending outwardly, as illustrated. The Y-shaped connector includes a web member 20 with V-shaped elongate members 30, 32 extending therefrom, as described above. Connector 10′″ is a Y-shaped connector with a web member 20 having a free end 20a, and V-shaped elongate members 34, 36 extending from an opposite end 20b of the web.

To create a continuous hinge, connector 10″ is cut to desired lengths. Connector 10′″ is cut to desired lengths slightly longer than the connectors 10″. Connectors 10″ and 10′″ are then slid in place, in alternating fashion in respective receiving slots 12 in panels P₁ and P₂, as shown in FIG. 16B. The two panels P₁, P₂ are then aligned, as illustrated in FIG. 16C, such that the alternating connectors 10″, 10′″ are intermeshed together. A hollow insert 72 is extended through the respective tubes 70 of the aligned connectors 10″. A threaded rod 80 is then extended through the insert 72 and is secured to the panels P1, P2 via a respective nut 82 at each end, as illustrated. This method can be used, not only for door hinge creation, but also for attaching pre-created panels temporarily or permanently. Potentially, such panels could be used for temporary or permanent erosion or flood control. Rebar or the like could be used to both create the attachment and a method of securing the assembly to the ground.

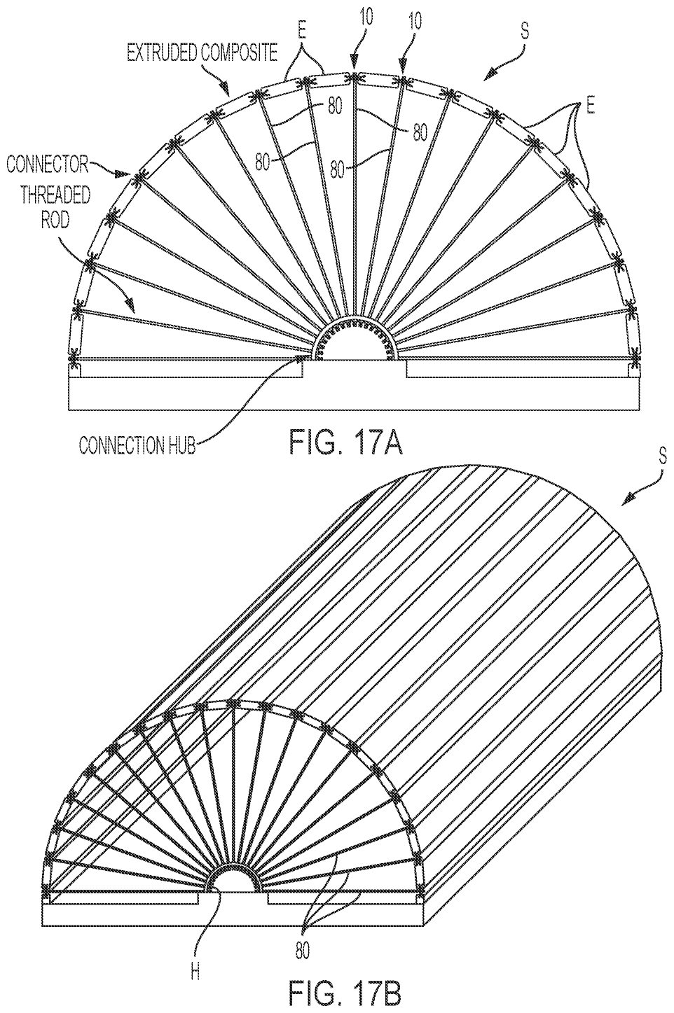

FIGS. 17A-17B illustrate a curved structure S that can be created utilizing connectors 10 of the present invention. Each connector 10 is similar to the connector 10 illustrated in FIGS. 2A-2B; however, the web member 20 between the V-shaped elongate members 30, 32 and 34, 36 is configured to have an end of a respective threaded rod secured thereto. A plurality of elements F are connected together via the connectors 10, as described above. The opposite end of each threaded rod 80 is secured to a hub H, as illustrated. As such, the structure S is created using tension and with no skeletal framework, in the same way a bicycle wheel uses tension pulling on a rim. Such a structure as illustrated in FIGS. 17A-17B may be utilized as a roof structure with a non-permeable surface. Although the structure S is shown as a semi-circle, one skilled in the art will recognize than changing the length of selected spokes (i.e., threaded rods 80) can result in an interesting variety of cross sectional geometries. This use of tension members (i.e., threaded rods 80) to create shapes can also be applied to shapes of cement forms.

Conventional methods of creating barriers, (temporary or permanent) are best suited to flat surfaces connected with nails, screws and the like. Embodiments of the present invention allow for the creation of curved and sinusoidal structures. The strength and stability of curved surfaces are well understood and appreciated. Traditional methods of creating curved structures are complex and typically require skilled engineers and craftsmen to create. Curved surfaces are less vulnerable to wind or water pressure. Temporary or permanent flood and erosion control can be assembled by semiskilled workers with the only tools required being a saw, tape measure and mallet for inserting connection members.

Building structures using embodiments of the present invention may be created with few if any traditional fasteners. Building connections using embodiments of the present invention are not subject to the “racking” of flat surfaces. Structures held together with nails, screws and boards require bracing and cross bracing to achieve strength. Longevity and strength are achieved using more materials and more mechanical fasteners. Embodiments of the present invention use geometric relationships to achieve strength and stability with less material, man hours, and skill.

Embodiments of the present invention are particularly well suited to landscaping, terracing and fencing. Green treated lumber used in exterior applications are used when wood will be in contact with soil. Virtually all wood posts are now made with rot resistant treated lumber. Attachment systems according to embodiments of the present invention can be used to create barriers and walls, concrete forms, tambour, free standing structures, staircases, decorative walls, and the like.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

That which is claimed is:

1. A connector, comprising:
an elongate web member;
a pair of first and second elongate members extending outward from one end of the web member at a first angle relative to each other, the first and second elongate members each comprising a respective longitudinal free end; and
a pair of third and fourth elongate members extending outward from an opposite end of the web member at a second angle relative to each other, the third and fourth elongate members each comprising a respective longitudinal free end.

2. The connector of claim 1, wherein the web member is bendable about a longitudinal axis thereof.

3. The connector of claim 2, wherein the web member comprises opposite first and second faces, and wherein at least one of the first and second faces comprises at least one elongate groove that facilitates bending of the web about the longitudinal axis thereof

4. The connector of claim 3, wherein both the first and second faces comprise a plurality of elongate, parallel grooves.

5. The connector of claim 1, wherein the web member comprises a longitudinally extending hollow member.

6. The connector of claim 5, wherein the hollow member has a substantially circular cross-section or a substantially polygonal cross-section.

7. The connector of claim 1, wherein the first and second angles are the same.

8. The connector of claim 1, wherein the first and second angles are between about ten degrees and seventy degrees (10°-70°).

9. The connector of claim 1, wherein a width of each of the first, second, third, and fourth elongate members is substantially the same.

10. The connector of claim 1, wherein the connector is fabricated from aluminum or polymeric material.

11. The connector of claim 1, wherein the connector is extruded from aluminum and wherein an outer surface thereof comprises an anodized coating.

12. A connector, comprising:
an elongate hollow member;
a first elongate Y-shaped connector extending outwardly from the elongate hollow member along a length thereof, the first elongate Y-shaped member comprising a pair of first and second elongate members oriented at a first angle relative to each other, the first and second elongate members each comprising a respective longitudinal free end; and
a second elongate Y-shaped connector extending outwardly from the elongate hollow member along a length thereof in circumferential spaced-apart relationship with the first elongate Y-shaped connector, the second elongate Y-shaped member comprising a pair of third and fourth elongate members oriented at a second angle relative to each other, the third and fourth elongate members each comprising a respective longitudinal free end.

13. The connector of claim 12, wherein the hollow member has a substantially circular cross-section or a substantially polygonal cross-section.

14. The connector of claim 12, wherein the first and second angles are the same.

15. The connector of claim 12, wherein the first and second angles are between about ten degrees and seventy degrees (10°-70°).

16. The connector of claim 12, wherein a width of each of the first, second, third, and fourth elongate members is substantially the same.

17. The connector of claim 12, wherein the connector is fabricated from aluminum or polymeric material.

18. The connector of claim 12, wherein the connector is extruded from aluminum and wherein an outer surface thereof comprises an anodized coating.

19. A structure, comprising:
a first element comprising a surface with a pair of angled elongate slots;
a second element comprising a surface with a pair of angled elongate slots; and
a connector joining the first and second elements, the connector comprising:
an elongate web member;
a pair of first and second elongate members extending outward from one end of the web member at a first angle relative to each other, the first and second elongate members each comprising a respective longitudinal free end, and wherein the first and second elongate members are inserted into the pair of angled elongate slots of the first element; and
a pair of third and fourth elongate members extending outward from an opposite end of the web member at a second angle relative to each other, the third and fourth elongate members each comprising a respective longitudinal free end, and wherein the third and fourth elongate members are inserted into the pair of angled elongate slots of the second element.

20. A structure, comprising:
a first element comprising a surface with a pair of angled elongate slots;
a second element comprising a surface with a pair of angled elongate slots; and
a connector joining the first and second elements, the connector comprising:
an elongate hollow member;
a first elongate Y-shaped connector extending outwardly from the elongate hollow member along a length thereof, the first elongate Y-shaped member comprising a pair of first and second elongate members oriented at a first angle relative to each other, the first and second elongate members each comprising a respective longitudinal free end, wherein the first and second elongate members are inserted into the pair of angled elongate slots of the first element; and
a second elongate Y-shaped connector extending outwardly from the elongate hollow member along a length thereof in circumferential spaced-apart relationship with the first elongate Y-shaped connector, the second elongate Y-shaped member comprising a pair of third and fourth elongate members oriented at a second angle relative to each other, the third and fourth elongate members each comprising a respective longitudinal free end, wherein the third and fourth elongate members are inserted into the pair of angled elongate slots of the second element.

21. The structure of claim 20, further comprising a threaded rod extending through the elongate hollow member, wherein one end of the threaded rod is secured to a foundation, and wherein a nut threadingly engages an opposite end of the threaded rod to secure the structure to the foundation.
